(19) United States
(12) Patent Application Publication
(10) Pub. No.: US 2007/0189774 A1
(43) Pub. Date: Aug. 16, 2007

(54) Method and arrangement for reducing spectral hole burning

(76) Inventors: Erich Gottwald, Holzkirchen (DE); Beate Konrad, Munchen (DE); Wolfgang Schairer, UnterschleiBheim (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/707,199

(22) Filed: Feb. 13, 2007

(30) Foreign Application Priority Data
Feb. 13, 2006 (DE) 102006006550.6

(51) Int. Cl. H04J 14/02

(52) U.S. Cl. 398/79

(57) ABSTRACT

In one aspect, a WDM signal is assigned to a number of sub-bands with the channel spacing being correspondingly enlarged in each sub-band. The spectral hole burning is hereby essentially reduced, since this effect is restricted to the adjacent channels. The complete WDM signal is first pre-amplified before being divided into sub-bands.

### CROSS REFERENCE TO RELATED APPLICATIONS

This application claims priority of German application No. 102006006550.6 DE filed Feb. 13, 2006, which is incorporated by reference herein in its entirety.

### FIELD OF INVENTION

The invention relates to a method and an arrangement for reducing spectral hole burning.

### BACKGROUND OF INVENTION

In optical networks, the transmission of wavelength multiplex signals (WDM signals) results in what is known as a spectral hole burning effect in the fiber amplifiers, which results in a reduction in the amplification in such channels, the adjacent channels of which exhibit a high signal power. This effect can be seen as disruptive, particularly when a number of fiber amplifiers are cascaded. The position and width of the “amplification hole” is dependent on the pump wavelength, the wavelength of the channels and their respective powers. In the case of a large number of channels, the effect caused by spectral hole burning can be compensated by means of a suitable tilt setting of the amplification profile and by a preemphase of the transmitted optical signals across the entire wave range.

If however several channels drop out (the term channels is used here for signals), the amplification of the others is changed. The failure of a number of active channels in proximity to an individual, furthermore active channel results in a high level jump in this channel.

Attempts were previously made to reduce the spectral hole burning effect with the aid of tilt compensators and appropriate regulation of the pump output. Such an amplifier is specified for example in WO 2001/54237 A1.

Spectral hole burning is likewise addressed in the patent application WO 00/21164 regarded as the closest prior art. In an amplifier unit, the C-band is divided into two sub-bands, which are amplified separately. The intention here is to facilitate dispersion compensation and to reduce spectral hole burning between the 1530 nm and 1550 nm amplification peaks. In the case of adjacent channels contrastingly spectral hole burning may not be reduced and with alternating channel occupancy unwanted significant level changes may also result.

The patent U.S. Pat. No. 6,621,626 B1 describes an amplifier arrangement to prevent crosstalk by means of four wave mixing. With this arrangement, the WDM signal to be amplified is divided into a number of sub-bands by way of a deinterleaver and individually allocated to a number of amplifiers, separately amplified and recombined to form a WDM signal. The spread of the channel spacing and thus the number of amplifiers are selected to be high in order to achieve the required cross talk attenuation. The spectral hole burning problem is not addressed here.

### SUMMARY OF INVENTION

An object of the invention is to specify a method and an arrangement to prevent spectral hole burning.

One particular advantage of this method is that even with rapid changes (transients) the signal level is problem-free. Other unwanted effects are also prevented between adjacent channels by means of channel spreading. It is desirable to provide channel spacing in the sub-bands from 200 GHz up to approximately 500 GHz, as the spectral hole burning effect is then negligible.

As the division into sub-bands requires a plurality of amplifiers, it is expedient to first carry out pre-amplification of the entire WDM signal, then divide this by means of the deinterleaver into several sub-bands with greater channel spacing and then feed each sub-band to an assigned power amplifier. The amplifiers however only need to supply a correspondingly lower power and can be more easily optimized in respect of the tilt for instance. The required pump lasers can also pump several amplifiers.

In order to reduce the outlay, it is furthermore expedient to carry out different channel spreading operations for different sub-bands according to the different effects of spectral hole burning.

### BRIEF DESCRIPTION OF THE DRAWINGS

The invention is now described below in more detail with reference to examples, in which;

FIG. 1 shows the division of the C-band into four sub-bands FIG. 2 shows a first arrangement according to the invention,

FIG. 3 shows a cost-optimized arrangement and

FIG. 4 shows a further cost-optimized arrangement.

### DETAILED DESCRIPTION OF INVENTION

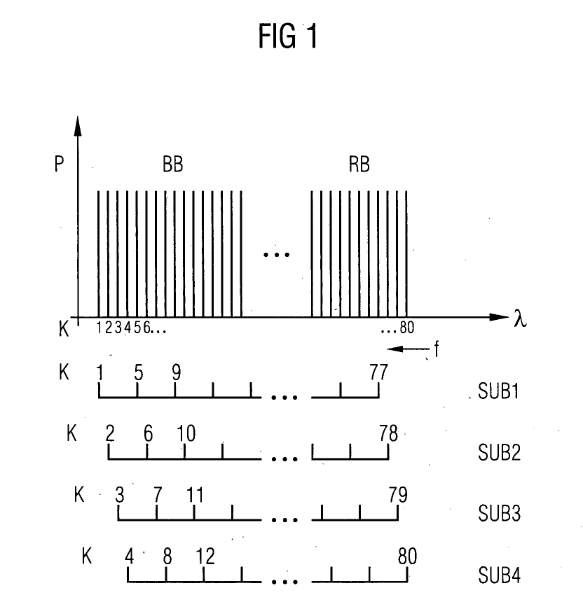

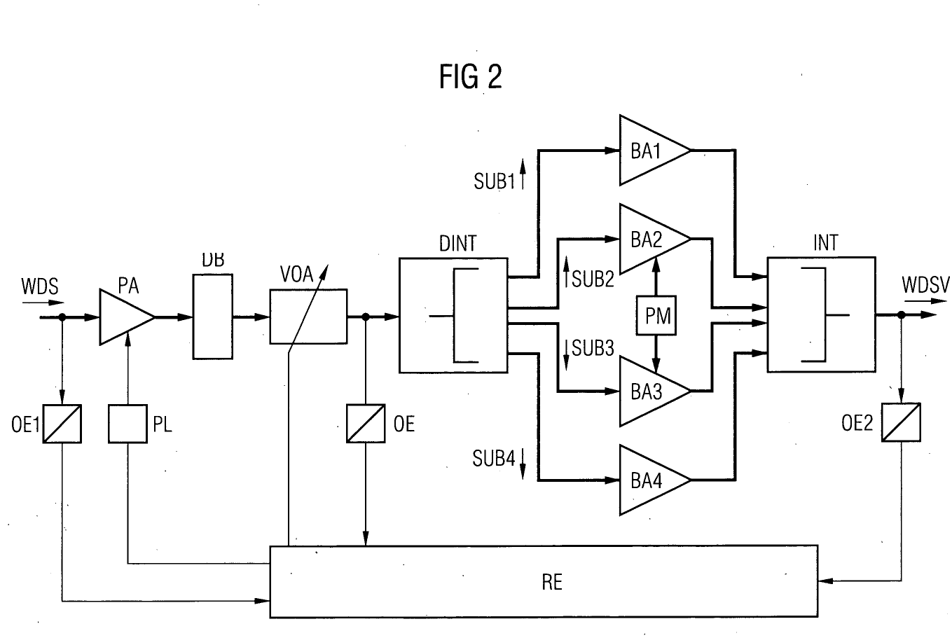

FIG. 1 shows the channel powers P of a fully occupied C-band (here approximately 191.8-196.1 THz used) with 80 channels K1-K80. These channels (in other words the signals transmitted in the channels) are assigned to four sub-bands SUB1 to SUB4 such that the channel spacing is at a maximum in each sub-band. The channels 1, 5, 9 to 77 are assigned to the first sub-band for instance, the channels 2, 6, 10, . . . to the second sub-band SUB2, the channels 3, 7, 11, . . . to SUB3 and finally the channels 4, 8, 12 to 80 to the fourth sub-band SUB4. Allocation to even more sub-bands, for instance to double the number, again reduces the spectral hole burning effect. The spectral hole burning is effective roughly in the region of ±2 nm or ±250 GHz of a signal. A channel spacing of 200 GHz in a sub-band already results in a mostly satisfactory improvement. With current WDM systems having 50 GHz channel spacing, this channel spacing can be particularly favorably realized by allocation to four sub-bands.

The main circuit diagram of a suitable amplifier arrangement is shown in FIG. 2. This contains, as its essential elements, a preamplifier PA, to which the WDM signal WDS to be amplified is fed, a deinterleaver DEINT arranged downstream of the preamplifier, said deinterleaver dividing the WWM signal into the four sub-bands SUB1-SUB4, four booster amplifiers (power amplifiers) BA1 to BA4, to which the sub-bands are fed and which can be pumped by a common pump module PM, an interleaver INT, which combines the output signals of the amplifiers into an amplified WDM signal WDSV and a regulation facility RE, to which at least the input signal and the output signal are fed via an optical-electrical converter OE1 or OE2 in each instance.

The amplifier arrangement can also contain various devices DB, such as a dispersion-compensating fiber, smoothing filters, insulators etc, likewise a variable attenuator VOA for level adjustment purposes and a separately controllable pump laser PL for the preamplifier PA. The booster amplifiers can be individually regulated. Not all optical-electrical converters OE and connectors are illustrated here for reasons of clarity.

The preamplifier PA first amplifies the complete incoming WDM signal WMS, before this is allocated to the sub-bands. This results overall in an improved signal-to-noise ratio. A variable attenuator VOA can likewise be arranged between the preamplifier and the second amplifier stages BA1-BA4, said attenuator serving for level regulation.

The preamplified WDM signal is fed to the deinterleaver DINT, where it is allocated to four sub-bands according to FIG. 1 with the lowest possible attenuation, said four sub-bands then being fed to the four booster amplifiers BA1 to BA4.

In the case of a regenerator or inline-amplifier, the amplified signals of the sub-bands are combined in the interleaver INT and are output as an amplified WDM signal WDSV. In the case of a receiving device, the sub-bands are contrastingly divided into individual channels (signals) by means of demultiplexers and are further processed after optical-electrical conversion.

The regulation facility RE is only shown schematically. It can be configured in any way, e.g. also to analyze channel occupancy and for instance to control the preamplifier, the variable attenuator and the booster amplifier separately according to the given requirements.

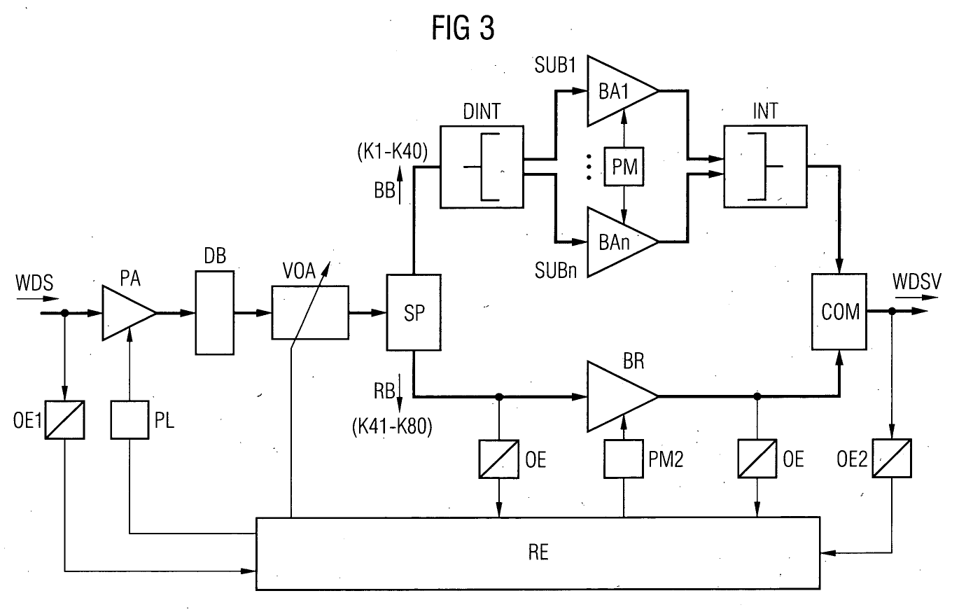

FIG. 3 shows a further amplifier arrangement, which requires less outlay and is thus more cost-effective. The received WDM signal WDS is first divided in a wavelength splitter SP into a “blue” first sub-band, comprising the channels 1 to 40, and a “red” second sub-band RB comprising the channels 41 to 80. As the red sub-band (the longer wavelength channels) is less susceptible to spectral hole burning, the sub-band RB is amplified in the booster amplifier BR in a closed state. This amplifier can be regulated separately, this being shown here by a second pump module PM2. The blue sub-band BB is divided as previously into a number of sub-bands, which are separately amplified by booster amplifiers BA1-BAn and are combined again in the interleaver INT. A combiner COM combines the amplified sub-bands BB, RB into the amplified output signal WDSV.

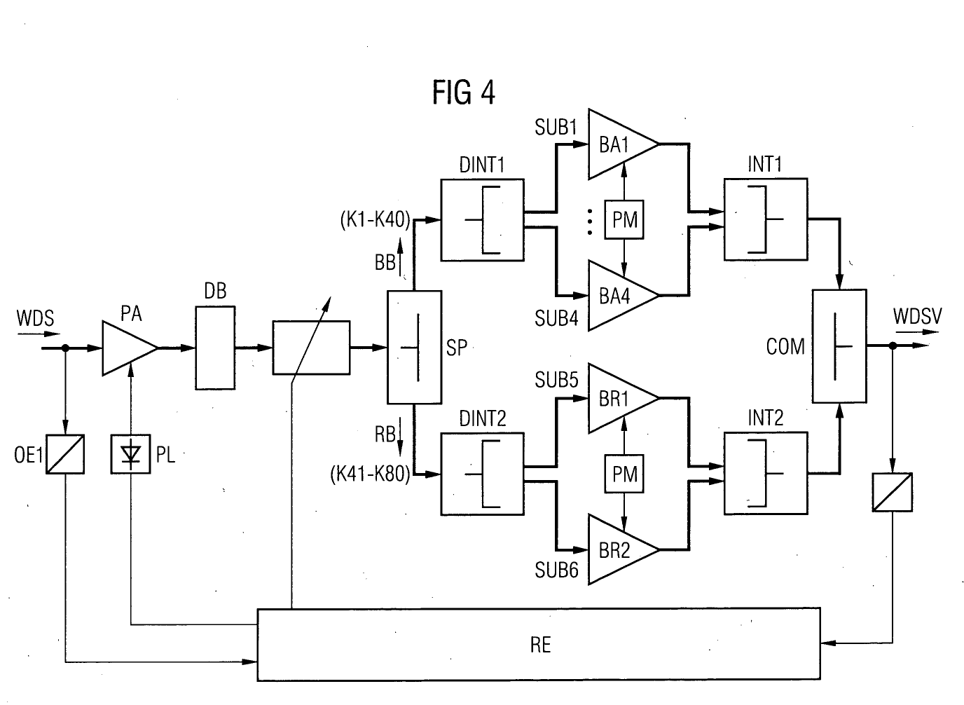

FIG. 4 shows a further variant, which represents a compromise between the arrangements described to date. The WDM signal WDS is again divided into two sub-bands BB and BR according to FIG. 3. The blue first sub-band BB with the channels K1-K40 is again divided in a first deinterleaver DINT1 into four sub-bands SUB1-SUB4, which are individually amplified in four booster amplifiers BA1-BA4. The red second sub-band with the channels K41-K80, which reacts less to spectral hole burning, is contrastingly divided in a second deinterleaver DINT2 into only two sub-bands SUB5 and SUB6 and is amplified in two booster amplifiers BR1 and BR2. This compromise between outlay and effect results in approximately the same spectral hole burning characteristics in the whole C-band. The sub-bands are reestablished by the interleavers INT1 and IND2, said sub-bands being combined to form the amplified output signal.

1.-14. (canceled)

15. A method for reducing spectral hole burning, comprising:
dividing a plurality of channels of a WDM signal into a plurality of sub-bands such that the channels are assigned cyclically to each sub-band; and
amplifying each of the sub-bands by a fiber amplifier.

16. The method as claimed in claim 15, wherein the assigning to the sub-bands is such that the channel spacing in the sub-bands amounts to 200 GHz.

17. The method as claimed in claim 15, further comprising amplifying the WDM signal in a closed state prior to the dividing.

18. The method as claimed in claim 15, further comprising combining the sub-bands to form an amplified WDM signal.

19. The method as claimed in claim 15, further comprising splitting the WDM signal into two signals having different frequency ranges, wherein the dividing is of at least one of the two split signals.

20. The method as claimed in claim 19, further comprising amplifying the WDM signal is in a closed state prior to the dividing.

21. The method as claimed in claim 19, further comprising combining the sub-bands to form an amplified WDM signal.

22. An arrangement for reducing spectral hole burning, comprising:
a first de-interleaver to which a WDM signal having a plurality of channels is fed and that divides the channels into a plurality of sub-bands such that the channels are assigned cyclically to each sub-band; and
a first plurality of booster amplifiers arranged such that each sub-channel is fed into one of the first plurality of amplifiers.

23. The arrangement as claimed in claim 22, wherein the de-interleaver is designed such that the channel spacing in each sub-band amounts to 200 GHz.

24. The arrangement as claimed in claim 22, further comprises a pre-amplifier arranged upstream of the de-interleaver in order to amplify the WDM signal.

25. The arrangement as claimed in claim 22, further comprises an interleaver or a combiner to combine to sub-bands to form an amplified WDM signal.

26. The arrangement as claimed in claim 22, further comprises an interleaver and a combiner to combine to sub-bands to form an amplified WDM signal.

27. The arrangement as claimed in claim 22,
further comprises a band splitter that splits the WDM signal into a plurality of sub-bands including a first sub-band and a second sub-band,
wherein the first sub-band is fed into the first de-interleaver and the second sub-band is fed to a further booster amplifier in a closed state.

28. The arrangement as claimed in claim 27, further comprises a pre-amplifier arranged upstream of the band splitter in order to amplify the WDM signal.

29. The arrangement as claimed in claim 22,
further comprises:
a band splitter that splits the WDM signal into a plurality of sub-bands including a first sub-band and a second sub-band,
a second de-interleaver to which the second sub-band having a plurality of channels is fed and that divides the channels into a further plurality of sub-bands such that the channels are assigned cyclically to each further sub-band; and
a second plurality of booster amplifiers arranged such that each further sub-channel is fed into one of the second plurality of amplifiers,
wherein the first sub-band is fed into the first de-interleaver.

30. The arrangement as claimed in claim 29, further comprises a pre-amplifier arranged upstream of the band splitter in order to amplify the WDM signal.
